(19) United States
(12) Patent Application Publication
(10) Pub. No.: US 2018/0132186 A1
(43) Pub. Date: May 10, 2018

(54) ACTIVITY SCHEDULING IN CONNECTED DISCONTINUOUS RECEPTION (CDRX) CYCLES FOR A MULTI-SUBSCRIBER IDENTITY MODULE (SIM) WIRELESS COMMUNICATION DEVICE

(71) Applicant: QUALCOMM Incorporated, San Diego, CA (US)

(72) Inventors: Mukesh Kumar, Hyderabad (IN); Anand Rajurkar, Hyderabad (IN); Suresh Sanka, Hyderabad (IN); Vishnu Namboodiri Karakkad Kesavan Namboodiri, Hyderabad (IN)

(21) Appl. No.: 15/486,279

(22) Filed: Apr. 12, 2017

(30) Foreign Application Priority Data
Nov. 4, 2016 (IN) 201641037764

(51) Int. Cl. H04W 52/02; H04W 76/04

(52) U.S. Cl. CPC H04W 52/0261; H04W 88/06; H04W 76/048

(57) ABSTRACT

Various embodiments described herein relate to a wireless communication device having a first Subscriber Identity Module (SIM) associated with a first subscription and a second SIM associated with a second subscription to manage communications over the first subscription and the second subscription. Some embodiments relate to identifying at least one sleep period of one or more Connected Discontinuous Reception (CDRX) cycles associated with the first subscription. Some embodiments further relate to performing at least a portion of one or more activities of the second subscription during the identified at least one sleep period.

### CROSS-REFERENCE TO RELATED PATENT APPLICATIONS

This application claims priority to Indian Application No. 201641037764, titled “filed on Nov. 4, 2016, incorporated herein by reference in its entirety.

### BACKGROUND

A wireless communication device, such as a mobile phone device or a smart phone, may include two or more Subscriber Identity Modules (SIMs). Each SIM may enable at least one subscription via a Radio Access Technology (RAT). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1×Radio Transmission Technology (1×), General Packet Radio Service (GPRS), Wi-Fi, Personal Communications Service (PCS), and other protocols that may be used in a wireless communications network or a data communications network.

A multi-SIM wireless communication device (e.g., an MSMS wireless communication device) may employ a Discontinuous Reception (DRX) mode to conserve power. The wireless communication device may be in a Connected DRX (CDRX) mode while in a Radio Resource Control (RRC)-connected state, as per Release 8, 3^{rd} Generation Partnership Project (3GPP). For example, when the wireless communication device is not engaged in active data transfer on a first subscription, a network associated with the first subscription may configure the first subscription of the wireless communication device to be in the CDRX mode. For example, a base station (e.g., an evolved Node B (eNodeB)) of the network of the first subscription may configure the wireless communication device into the CDRX mode. In a cycle of the CDRX mode, the wireless communication device may be awake (engaged in activities with Radio Frequency (RF) resources of the wireless communication device) for a period of time (e.g., an awake period or “on duration”) for monitoring a Physical Downlink Shared Channel (PDSCH). Within the same cycle, the wireless communication device may sleep (not engaged in reception activities by idling the RF resource) for a period of time (e.g., a sleep period or “off duration”) to conserve power.

In some instances, activities of a second subscription of the multi-SIM wireless communication device may occur during the awake period or inactivity timer duration of the first subscription. Such activities may include page decoding or other idle-mode activities of the second subscription. Given that idle-mode activities of the second subscription may have priority over first subscription activities in the awake period or in the inactivity timer duration, the wireless communication device may not decode the PDSCH for the first subscription if the first subscription awake period or the inactivity timer duration overlaps with the time the activities of the second subscription occur. Thus, if the network allocates downlink data for the first subscription in the PDSCH and the corresponding portion of the first subscription awake period collides with the time the activities of the second subscription occur, the first subscription may not be able to decode the allocated downlink data.

### SUMMARY

Embodiments described herein are related to scheduling Radio Frequency (RF) resource usage in a wireless communication device such as, but not limited to, a Multi-SIM-Multi-Standby (MSMS) wireless communication device, to avoid interruptions of data calls by an active subscription. The wireless communication device may have a first (active) subscription in a Connected DRX (CDRX) mode and a second (idle) subscription. The first subscription may be enabled by a first Subscriber Identity Module (SIM). The second subscription may be enabled by a second SIM. Activities (e.g., pages or other idle mode reception activities) of the second subscription may have higher priority than that of the CDRX activities of the first subscription. A CDRX cycle of the first subscription may include an awake period and a sleep period. In some embodiments, the wireless communication device may allocate and perform idle subscription activities during the discrete sleep periods of the CDRX cycle of the active subscription. As such, interruption of data calls due to tune away from the active subscription to the idle subscription for performance of idle activities by the second subscription can be minimized. Accordingly, data throughput reduction may be minimized and power conservation may be increased, as the wireless communication device may spend less energy reestablishing synchronization that is lost due to tune away.

According to various embodiments, there is provided a method for a wireless communication device having a first Subscriber Identity Module (SIM) associated with a first subscription and a second SIM associated with a second subscription to manage communications over the first subscription and the second subscription. The method includes identifying at least one sleep period of one or more Connected Discontinuous Reception (CDRX) cycles associated with the first subscription. The method further includes performing at least a portion of one or more activities of the second subscription during the identified at least one sleep period.

In some embodiments, the method further includes identifying an estimated time to complete the one or more activities, determining a duration of the at least one sleep period, and determining whether the duration of the at least one sleep period exceeds the estimated time to complete the one or more activities.

In some embodiments, the method further includes, in response to determining that the duration of the at least one sleep period exceeds the estimated time to complete the one or more activities, scheduling the one or more activities for execution during the at least one sleep period.

In some embodiments, the method further includes, in response to determining that the duration of the at least one sleep period is less than the estimated time to complete the one or more activities, identifying a sleep period of a subsequent CDRX cycle associated with the first subscription, wherein a duration of the sleep period of the subsequent CDRX cycle is equal to or greater than the estimated time to complete the one or more activities.

In some embodiments, the one or more activities of the second subscription includes idle mode reception activities of the second subscription.

In some embodiments, the idle mode reception activities of the second subscription includes receiving and decoding pages of the second subscription.

In some embodiments, the method further includes splitting an idle activity of the one or more activities into a first sub-activity and a second sub-activity, and scheduling the first sub-activity for execution during a first sleep period of the at least one sleep periods and the second sub-activity for execution during a second sleep period of the at least one sleep periods.

In some embodiments, the first sleep period is associated with a first CDRX cycle of the one or more CDRX cycles and the second sleep period is associated with a second CDRX cycle of the one or more CDRX cycles, and the second CDRX cycle is different from and subsequent to the first CDRX cycle.

In some embodiments, the one or more activities of the second subscription includes a first activity and a second activity.

In some embodiments, the method further includes identifying an estimated time to complete the first activity and the second activity, determining a duration of one of the at least one sleep period, and determining whether the duration of the one of the at least one sleep period exceeds the estimated time to complete the first activity and the second activity.

In some embodiments, the method further includes, in response to determining that the duration of the one of the at least one sleep period exceeds the estimated time to complete the first activity and the second activity, scheduling the first activity and the second activity for execution during the one of the at least one sleep period.

In some embodiments, the first subscription is a Long Term Evolution (LTE) subscription associated with the CDRX.

According to various embodiments, there is provided a wireless communication device, including memory, at least one Radio Frequency (RF) resource, and a processor operably connected to the at least one RF resource configured to connect to a first Subscriber Identity Module (SIM) associated with a first subscription and to a second SIM associated with a second subscription. The processor is further configured to identify at least one sleep period of one or more Connected Discontinuous Reception (CDRX) cycles associated with the first subscription, and perform at least a portion of one or more activities of the second subscription during the identified at least one sleep period.

In some embodiments, the processor is further configured to identify an estimated time to complete the one or more activities, determine a duration of the at least one sleep period, and determine whether the duration of the at least one sleep period exceeds the estimated time to complete the one or more activities

In some embodiments, the processor is further configured to, in response to determining that the duration of the at least one sleep period exceeds the estimated time to complete the one or more activities, schedule the one or more activities for execution during the at least one sleep period.

In some embodiments, the processor is further configured to, in response to determining that the duration of the at least one sleep period is less than the estimated time to complete the one or more activities, identify a sleep period of a subsequent CDRX cycle associated with the first subscription, wherein a duration of the sleep period of the subsequent CDRX cycle is equal to or greater than the estimated time to complete the one or more activities.

In some embodiments, the one or more activities of the second subscription includes idle mode reception activities of the second subscription.

In some embodiments, the idle mode reception activities of the second subscription includes receiving and decoding pages of the second subscription.

In some embodiments, the processor is further configured to split an idle activity of the one or more activities into a first sub-activity and a second sub-activity, and schedule the first sub-activity for execution during a first sleep period of the at least one sleep periods and the second sub-activity for execution during a second sleep period of the at least one sleep periods.

In some embodiments, the first sleep period is associated with a first CDRX cycle of the one or more CDRX cycles and the second sleep period is associated with a second CDRX cycle of the one or more CDRX cycles, and the second CDRX cycle is different from and subsequent to the first CDRX cycle.

In some embodiments, the one or more activities of the second subscription includes a first activity and a second activity.

In some embodiments, the processor is further configured to identify an estimated time to complete the first activity and the second activity, determine a duration of one of the at least one sleep period, and determine whether the duration of the one of the at least one sleep period exceeds the estimated time to complete the first activity and the second activity.

In some embodiments, the processor is further configured to, in response to determining that the duration of the one of the at least one sleep period exceeds the estimated time to complete the first activity and the second activity, schedule the first activity and the second activity for execution during the one of the at least one sleep period.

In some embodiments, the first subscription is a Long Term Evolution (LTE) subscription associated with the CDRX.

According to various embodiments, an apparatus for a wireless communication device having a first Subscriber Identity Module (SIM) associated with a first subscription and a second SIM associated with a second subscription to manage communications over the first subscription and the second subscription, the apparatus including means for identifying at least one sleep period of one or more Connected Discontinuous Reception (CDRX) cycles associated with the first subscription, and means for performing at least a portion of one or more activities of the second subscription during the identified at least one sleep period.

In some embodiments, the apparatus further includes means for identifying an estimated time to complete the one or more activities, means for determining a duration of the at least one sleep period, and means for determining whether the duration of the at least one sleep period exceeds the estimated time to complete the one or more activities.

In some embodiments, the apparatus further includes, in response to determining that the duration of the at least one sleep period exceeds the estimated time to complete the one or more activities, means for scheduling the one or more activities for execution during the at least one sleep period.

According to various embodiments, there is provided a non-transient computer-readable medium including program instructions that, when executed, cause a computer to identify at least one sleep period of one or more Connected Discontinuous Reception (CDRX) cycles associated with the first subscription, and perform at least a portion of one or more activities of the second subscription during the identified at least one sleep period.

In some embodiments, the program instructions further cause the computer to identify an estimated time to complete the one or more activities, determine a duration of the at least one sleep period, and determine whether the duration of the at least one sleep period exceeds the estimated time to complete the one or more activities.

In some embodiments, the program instructions further cause the computer to, in response to determining that the duration of the at least one sleep period exceeds the estimated time to complete the one or more activities, schedule the one or more activities for execution during the at least one sleep period.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a wireless communication device according to various embodiments.

FIG. 3 is a process flowchart diagram illustrating an example of a scheduling method according to various embodiments.

FIG. 4 is a schematic diagram illustrating an example of scheduling idle activities according to various embodiments.

FIG. 5 is a process flow diagram illustrating an example of a scheduling method according to various embodiments.

FIG. 6 is a component block diagram of a wireless communication device suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a wireless communication device, User Equipment (UE), or Mobile Station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that provide users of the wireless communication devices with access to one or multiple separate mobile communication networks. The mobile communication networks may be supported by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), High-Speed Downlink Packet Access (HSDPA), and the like), Global System for Mobile Communications (GSM), Code Division Multiple Access 1×Radio Transmission Technology (1×), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more subscriptions with one subscription being active at a given time may be a Multi-SIM-Multi-Standby (MSMS) communication device. In one example, the MSMS communication device may be a Dual-SIM-Dual-Standby (DSDS) communication device, which may include two SIMs that may both be active on standby, but one may be deactivated when the other one may be activated. In another example, the MSMS communication device may be a Triple-SIM-Triple-Standby (TSTS) communication device, which includes three SIMs that may all be active on standby, where two may be deactivated when the third one may be in use. In other examples, the MSMS communication device may be other suitable multi-SIM communication devices, with, for example, four or more SIMs, such that when one may be in use, the others may be deactivated.

On the other hand, a wireless communication device that includes a plurality of SIMs and connects to two or more separate (or same) subscriptions or networks with two or more subscriptions or networks being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, embodiments described herein may be applicable to a MSMS wireless communication device having at least a first SIM and a second SIM. Illustrating with a non-limiting example, the first SIM may be associated with a first subscription, and the second SIM may be associated with a second subscription. The first subscription may be an LTE (Frequency Division Duplex (FDD)) subscription. The second subscription may be another suitable subscription such as, but not limited to, a GSM subscription. Additionally or alternatively, the embodiments may be applicable to a MSMA wireless communication device having its first subscription blanked by activities (also referring to activity) of the second subscription due to interference, activity pattern, power back-off, and/or the like associated with the second subscription, such that activities of the second subscription may cause interruptions to the first subscription in a manner similar to described with respect to tune-aways.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless device on a network and enable communication services with the network. Because the information stored in a SIM may be the wireless device to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

Referring generally to the FIGS., embodiments described herein are concerned with scheduling activities of an idle SIM for a wireless communication device in a Connected Discontinuous Reception (CDRX) mode. The CDRX mode may be used to conserve power. For example, a given CDRX cycle may include the awake period and a sleep period (e.g., an off duration). The wireless communication device may shut off a Radio Frequency (RF) resource during the sleep period to conserve power. A network (e.g., a base station associated thereof) may not schedule transmissions with the wireless communication during the sleep period of that wireless communication device.

A CDRX cycle may be classified as a Short CDRX cycle or Long CDRX cycle. For instance, the wireless communication device may first be in a Short CDRX cycle and transitions into a Long CDRX cycle after expiration of an inactivity timer. Embodiments described herein relate to both the Short CDRX cycles and Long CDRX cycles. Thus, “CDRX cycle” as used herein may refer to the Short CDRX cycle or Long CDRX cycle. Illustrating with a non-limiting example, a Long CDRX cycle may have a length of 320 ms, with the awake period having a length of 10 ms. The sleep period of the Long CDRX may have a length of 310 ms. Illustrating with another non-limiting example, a Short CDRX cycle may have a length of 40 ms, with the awake period having a length of 10 ms. The sleep period of the Short CDRX may have a length of 30 ms. Other suitable lengths of the Short CDRX cycle or Long CDRX cycle may likewise benefit from the embodiments described herein.

In some embodiments, the idle activities of the second subscription may be scheduled during sleep periods of the first subscription. Tune-aways corresponding to the activities of the second subscription may have a higher priority than that of the awake period of the CDRX cycle. Thus, if the tune-away to the second subscription collides or overlaps with the awake period of the first subscription, the awake period may be interrupted or cut short in favor of tuning away to the second subscription. Accordingly, to minimize the interruption of data at the first subscription due to the tune-away to the second subscription, the activities to be performed by the second subscription during the tune-away may be strategically scheduled to be performed during the discrete sleep periods of the CDRX cycles of the first subscription. This reduces the throughput reduction on an LTE DATA SUB by placing the idle SUB activities on a CDRX gap available.

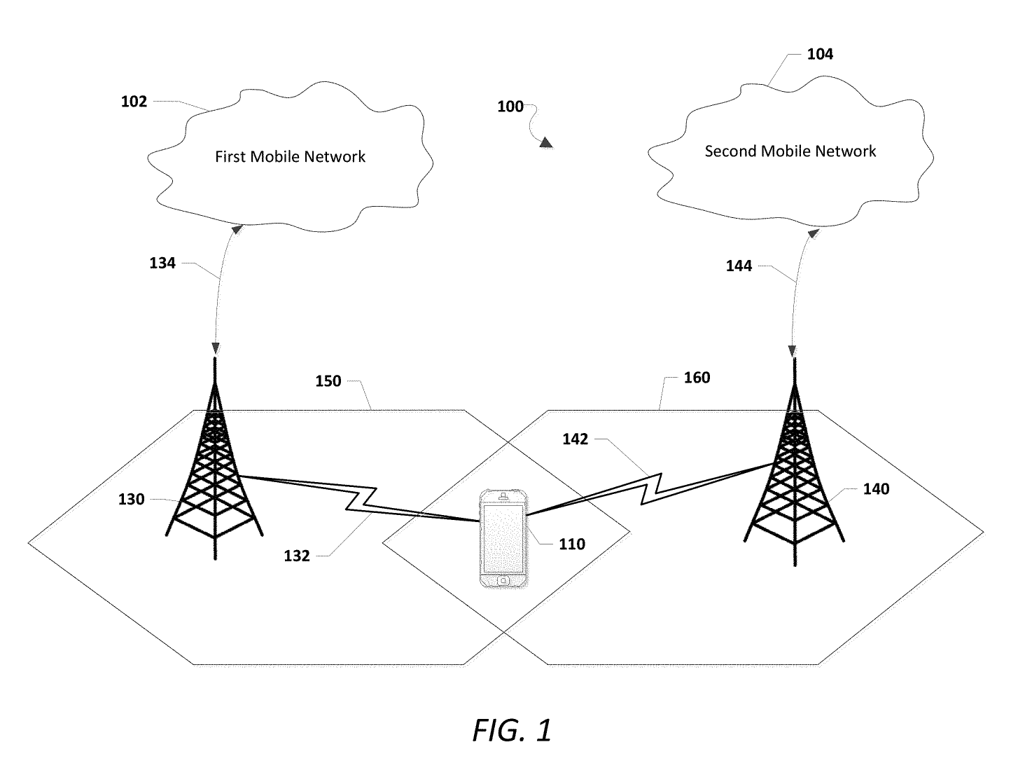

Various embodiments may be implemented within a communication system 100, an example of which is illustrated in FIG. 1. Referring to FIG. 1, a first mobile network 102 and a second mobile network 104 may each associate with a plurality of cellular base stations (e.g., a first base station 130 and a second base station 140, respectively). The first base station 130 may broadcast the first mobile network 102 in a first serving cell 150. The second base station 140 may broadcast the second mobile network 104 in a second serving cell 160. A wireless communication device 110 may be associated with (within effective boundaries of) both the first serving cell 150 and the second serving cell 160.

The wireless communication device 110 may be in communication with the first mobile network 102 through a first cellular connection 132 to the first base station 130. The first cellular connection 132 may correspond to the first RAT of the wireless communication device 110. The wireless communication device 110 may also be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by any suitable protocol (RAT) including, but not limited to, FDMA, TDMA, CDMA (e.g., EVDO), UMTS (e.g., WCDMA, LTE, HSDPA, or the like), GSM, 1×, GPRS, Wi-Fi, PCS, and/or another protocol used in a wireless communications network or a data communications network. By way of illustrating with a non-limiting example, the first cellular connection 132 may be a LTE connection. The second cellular connection 142 may be a LTE, WCDMA, GSM; or 1×connection. Other RATs (such as, but not limited to, HSDPA, EVDO, and the like) may be implemented in a similar manner.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNodeB or eNB), base transceiver station (BTS), or the like.

In various embodiments, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is inserted, the wireless communication device 110 may access the mobile communication network associated with that RAT based on the information stored on the SIM through registrations and call setups.

While the wireless communication device 110 is shown connected to the mobile networks 102 and 104 via two cellular connections, in other embodiments (not shown), the wireless communication device 110 may establish additional network connections using at least one additional RAT.

In some embodiments, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some embodiments, the wireless communication device 110 may establish a wireless connection with a wireless access point (not shown), such as over a Wi-Fi connection. The wireless access point may be configured to connect to the Internet or another network over a wired connection.

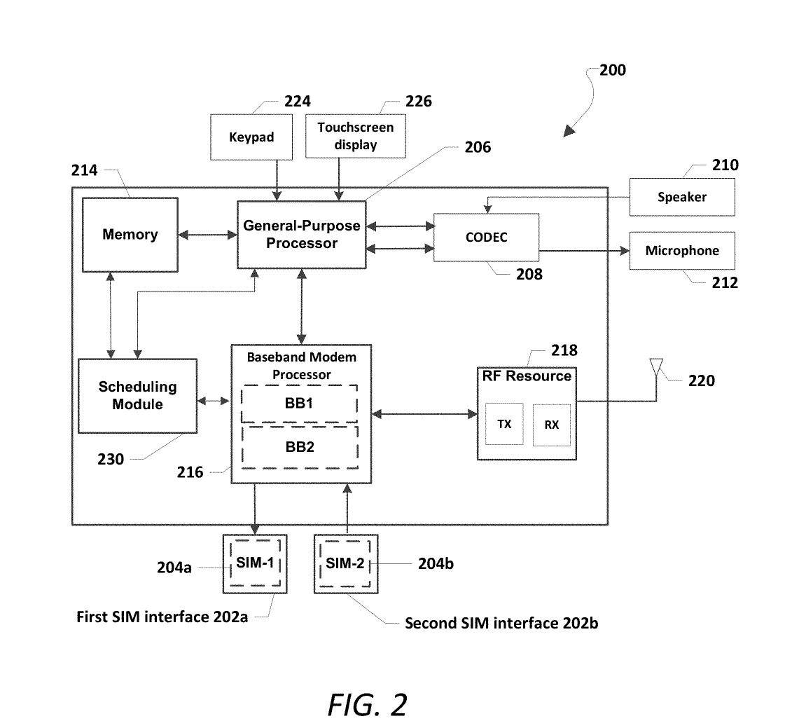

FIG. 2 is a functional block diagram of a wireless communication device 200 suitable for implementing various embodiments. According to various embodiments, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a that is associated with the first subscription (corresponding to the first mobile network 102). The wireless communication device 200 may also include a second SIM interface 202b, which may receive a second identity module SIM-2 204b associated with the second subscription (corresponding to the second mobile network 104).

A SIM (e.g., SIM-1 204a, SIM-2 204b, and/or the like) in various embodiments may be a Universal Integrated Circuit Card (UICC) configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. However, a SIM may be implemented within a portion of memory of the wireless communication device 200, and thus need not be a separate or removable circuit, chip, or card.

A SIM used in various embodiments may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The embodiments described herein may be applicable to wireless communication devices in which the SIMs 204a and 204b share a common set of RF resource (particularly, the RF resource 218). Embodiments described herein may also be applicable to wireless communication devices in which each of the SIMs 204a and 204b has a separate RF resource, but activities of one of the SIMs 204a and 204b may be deactivated while the other one of the SIMs 204a and 204b is active.

The RF resource 218 may include at least one transceiver that perform transmit/receive functions for the associated SIMs 204a and 204b of the wireless communication device 200. The RF resource 218 may include separate transmit and receive circuitry, or may include a transceiver that combines transmitter and receiver functions. The RF resource 218 may be coupled to a wireless antenna 220. The RF resource 218 may also be coupled to the baseband modem processor 216.

In some embodiments, the general-purpose processor 206, the memory 214, the baseband modem processor 216, and the RF resource 218 may be included in the wireless communication device 200 as a system-on-chip. In some embodiments, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them.

The wireless communication device 200 may include a scheduling module 230 configured to perform the functions described herein with respect to scheduling activities of the first subscription and the second subscription. The scheduling module 230 may communicate with the software layers corresponding to both the first subscription and the second subscription. Particularly, the scheduling module 230 may communicate with the software layer (e.g., L1) corresponding to the second subscription to obtain activities of the second subscription that have been scheduled in advance. The scheduling module 230 may use the information regarding the future activities of the second subscription to schedule those activities in the manner described (e.g., scheduled during sleep periods of one or more CDRX cycles).

In some embodiments, the scheduling module 230 may be implemented within the general-purpose processor 206. For example, the scheduling module 230 may be implemented as a software application stored within the memory 214 and executed by the general-purpose processor 206. Accordingly, such embodiments can be implemented with minimal additional hardware costs. However, other embodiments relate to systems and processes implemented with dedicated hardware specifically configured for performing operations described herein with respect to the scheduling module 230. For example, the scheduling module 230 may be implemented as a separate processing component (i.e., separate from the general-purpose processor 206). The scheduling module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further embodiments, such hardware and/or software may be added to the wireless communication device 200 post-manufacture, such as by installing one or more hardware devices and/or software applications onto the wireless communication device 200.

In some embodiments, the wireless communication device 200 may include, among other things, additional SIM cards, SIM interfaces, at least another RF resource associated with the additional SIM cards, and additional antennas for connecting to additional mobile networks.

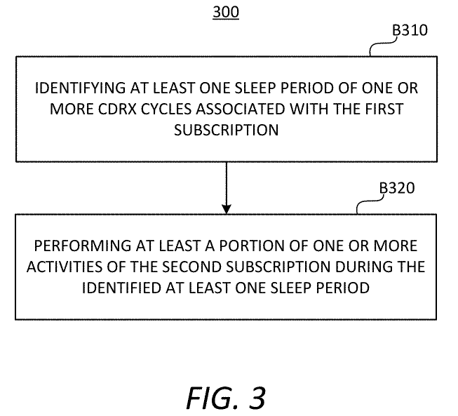

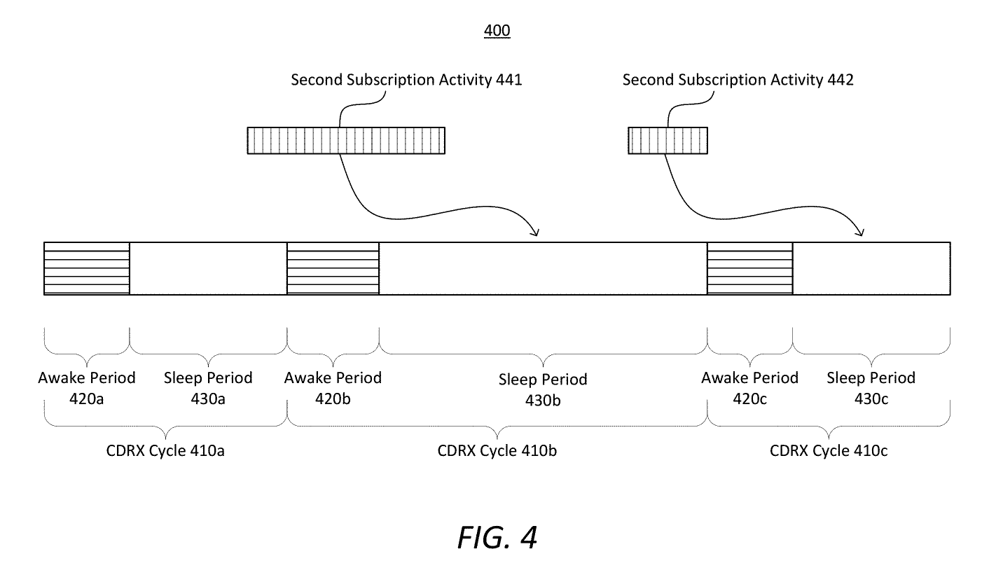

FIG. 3 is a process flowchart diagram illustrating an example of a scheduling method 300 according to various embodiments. FIG. 4 is a schematic diagram 400 illustrating an example of scheduling idle activities in CDRX cycles 410a, 410b, and 410c (e.g., first CDRX cycle 410a, second CDRX cycle 410b, and third CDRX cycle 410c) according to various embodiments.

Referring to FIGS. 1-4, the CDRX cycles 410a, 410b, and 410c may include respective awake periods 420a, 420b, and 420c (e.g., first awake period 420a, second awake period 420b, and third awake period 420c) and respective sleep periods 430a, 430b, and 430c (e.g., first sleep period 430a, second sleep period 430b, and third sleep period 430c). The CDRX cycles 410a, 410b, and/or 410c may be a Long CDRX cycle or a Short CDRX cycle. The diagram 400 also includes a (first) second subscription activity 441 and a (second) second subscription activity 442. The second subscription activities 441 and 442 may be idle activities that would conventionally interrupt data throughput at the first subscription when performed during the awake periods, 420a, 420b, and 420c, of the first subscription (e.g., due to tune-away to the second subscription for performance of the activities 441 and 442).

During the awake periods 420a, 420b, and 420c, the scheduling module 230 or the general-purpose processor 206 may configure the RF resource 218 to monitor downlink data in a PDSCH. The first mobile network 102 (e.g., the first base station 130) may send any downlink data blocks or downlink grants (collectively referred to as downlink data) to the wireless communication device 200 (110) during the awake periods 420a, 420b, and 420c. Conventionally during the sleep periods 430a, 430b, and 430c, the RF resource 218 may be shut off to conserve power. That is, the wireless communication device 200 may not receive any downlink data during the sleep periods 430a, 430b, and 430c.

In some embodiments, at block B310, the scheduling module 230 or the general-purpose processor 206 may identify at least one sleep period 430a, 430b, or 430c of at least one CDRX cycle 410a, 410b, or 410c associated with the first subscription (enabled by SIM-1 204a). The activities of the second subscription may be represented by the second subscription activities 441 and 442. Examples of the second-subscription activities 441 and 442 may include, but not be limited to, pages, neighbor cell searches, location updates, full cell search, a combination thereof, and/or the like. In some embodiments, the second subscription activities 441 and 442 may correspond to idle mode processes such as idle mode reception activities, including receiving and decoding pages of the second subscription. The RF resource 218 may be tuned away to the second subscription for the second subscription activities 441 and 442 in an MSMS context.

As shown in the non-limiting example presented by FIG. 4, the first CDRX cycle 410a may be a Short CDRX cycle, the second CDRX cycle 410b may be a Long CDRX cycle, and the third CDRX cycle 410c may be a Short CDRX cycle. In some embodiments, at block B320, the scheduling module 230 or the general-purpose processor 206 may perform at least a portion of an activity of the second subscription 441 or 442 during the identified at least one sleep period 430a, 430b, or 430c. In some embodiments, the second subscription activity 441 or 442 is aligned with one or more of the sleep periods 430a, 430b, or 430c by the scheduling module 230 or the general-purpose processor 206 determining which activity 441 or 442 is compatible for which sleep periods 430a, 430b, or 430c (e.g., based on the duration of the sleep period 430a, 430b, or 430c and the estimated time the second subscription activity 441 or 442 will take). As an example, the scheduling module 230 or the general-purpose processor 206 may determine that the first second subscription activity 441 can be performed within the time frame of the second sleep period 430b and that the second second subscription activity 442 can be performed within the time frame of the third sleep period 430c. As such, the scheduling module 230 or the general-purpose processor 206 may schedule the second subscription activities 441 and 442 accordingly, for example, by scheduling the first second subscription activity 441 during the second sleep period 430b and the second second subscription activity 442 during the third sleep period 430c.

In some embodiments, awake periods occur after a second subscription activity is performed during a sleep period. As an example, as shown in FIG. 4, the second subscription activity 441 is scheduled and performed during the second sleep period 430b of the second CDRX cycle 410b, and the awake period 420c of the third CDRX cycle 410c occurs thereafter. In some embodiments, no gap may occur between a second subscription activity and an awake period following the second subscription activity. For example, the awake period 420c may occur directly after the second subscription activity 441 occurs with no gap therebetween. In other embodiments, a gap (e.g., 1 ms, 2 ms, 5 ms, and/or the like) may be provided between the awake period following the second subscription activity.

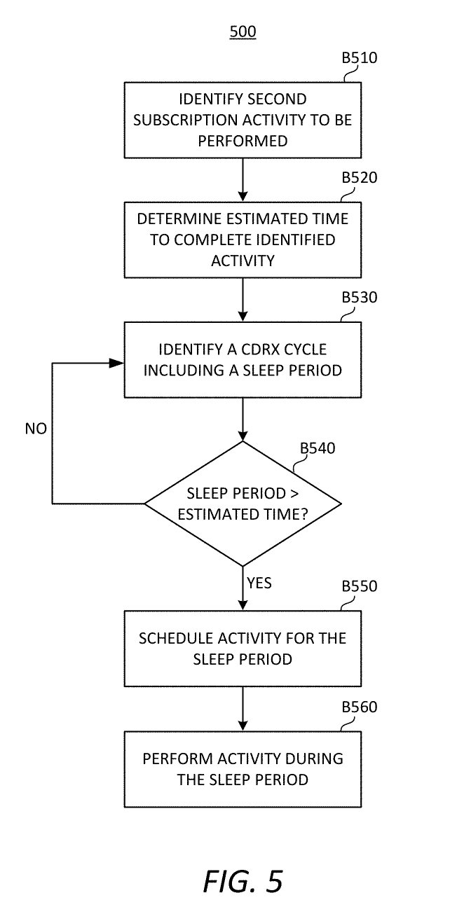

FIG. 5 is a process flow diagram illustrating an example of a scheduling method 500 according to various embodiments. Referring to FIGS. 1-5, one or more of blocks B510-B560 may correspond to one or more of blocks of B310-B320. At block B510, the scheduling module 230 or the general-purpose processor 206 may identify at least one second subscription activity (e.g., an idle activity) to be performed by the wireless communication device 200. In some embodiments, the scheduling module 230 or the general-purpose processor 206 communicates with the second SIM interface 202b to determine the second subscription activity to be performed.

In some embodiments, the scheduling module 230 or the general-purpose processor 206 identifies a plurality of second subscription activities to be performed by the second subscription and categorizes each of the second subscription activities into smaller units (e.g., such as the smaller unit second subscription activities 441 and 442). For example, with respect to a second subscription activity (e.g., activity of the idle subscription), the scheduling module 230 or the general-purpose processor 206 may categorize a first second subscription activity (e.g., activity 441) as a cell search activity and may categorize a second second subscription activity as a cell measurement activity (e.g., activity 442). In further embodiments, the scheduling module 230 or the general-purpose processor 206 may identify even smaller performable units of an activity (e.g., performable sub-activities of a cell measurement activity). In other embodiments, the second subscription activities include intra-frequency monitoring and/or inter-RAT monitoring, which may be performed in a periodic manner (e.g., performed twice every 500 ms).

At block B520, the scheduling module 230 or the general-purpose processor 206 may determine an estimated time to complete the second subscription activity identified in block B510. In some embodiments, the wireless communication device 200 stores (e.g., in memory 214) information regarding estimated times associated with second subscription activities. For example, the memory 214 may store a look-up table including data regarding estimated time to complete idle activities (e.g., 2 ms to 3 ms for performing a page decoding activity). In other embodiments, the scheduling module 230 or the general-purpose processor 206 receive estimated time information via the second SIM interface 202b.

At block B530, the scheduling module 230 or the general-purpose processor 206 may identify a CDRX cycle including a sleep period of the first subscription. In some embodiments, the scheduling module 230 or the general-purpose processor 206 identifies a plurality of CDRX cycles including respective sleep periods. In some embodiments, the first subscription indicates (e.g., provides information) to the scheduling module 230 or the general-purpose processor 206 regarding upcoming CDRX cycles and whether each of those CDRX cycles is a Long CDRX cycle or a Short CDRX cycle. In some embodiments, the first subscription further provides information to the scheduling module 230 or the general-purpose processor 206 regarding lengths of respective sleep periods of upcoming CDRX cycles. For example, the first subscription may indicate that the three upcoming CDRX cycles are CDRX cycle 410a that is a Short CDRX cycle, CDRX cycle 410b that is a Long CDRX cycle, and CDRX cycle 410c that is also a short CDRX cycle, and the first subscription may further indicate the length of each of the respective sleep periods 430a, 430b, and 430c of the CDRX cycles 410a, 410b, and 410c.

At block B540, the scheduling module 230 or the general-purpose processor 206 determines whether the sleep period of the CDRX cycle identified in block B530 is greater than the estimated time to complete the second subscription activity. In some embodiments, if the sleep period is greater than (or equal to) the estimated time (B540: YES), then the method 500 proceeds to block B550. However, if the sleep period is less than (or equal to) the estimated time (B540: NO), then the method 500 returns to block B530 and the scheduling module 230 or the general-purpose processor 206 identifies another CDRX cycle (e.g., a subsequent CDRX cycle) having a sleep period. For example, the scheduling module 230 or the general-purpose processor 206 may determine that the estimated time for performing the second subscription activity 441 is greater than the sleep period 430a of the first CDRX cycle 410a, and thus the scheduling module 230 or the general-purpose processor 206 may identify the subsequent second CDRX cycle 410b and determine whether the sleep period 430b can accommodate execution of the second subscription activity 441.

In some embodiments, the scheduling module 230 or the general-purpose processor 206 further splits the second subscription activity into smaller units or portions (e.g., sub-activities) for performance within multiple separate sleep periods. For example, the scheduling module 230 or the general-purpose processor 206 may split performance of the second subscription activity 441 in half and determine that the first half of the second subscription activity 441 can be performed within the first sleep period 430a and the second half of the second subscription activity 441 can be performed within the second sleep period 430b (or the third sleep period 430c). In some embodiments, the scheduling module 230 or the general-purpose processor 206 determines that a plurality of second subscription activities (e.g., a first activity and a second activity) can be performed within one sleep period for a CDRX cycle. For example, the scheduling module 230 or the general-purpose processor 206 may determine that the first second subscription activity 441 and the second second subscription activity 442 can both be performed within the second sleep period 430b.

At block B550, in response to the sleep period being greater than (or equal to) the estimated time (B540: YES), the scheduling module 230 or the general-purpose processor 206 may schedule the second subscription activity for the identified sleep period during which the second subscription activity is able to be completed. In some embodiments, the scheduling module 230 or the general-purpose processor 206 schedules a single second subscription activity (e.g., in portions) into a plurality of sleep periods of different CDRX cycles. In some embodiments, the scheduling module 230 or the general-purpose processor 206 schedules a plurality of second subscription activities within a single sleep period of a CDRX cycle. In some embodiments, the scheduling module 230 or the general-purpose processor 206 delays performance of the second subscription activity until the identified sleep period is activated.

At block B560, the scheduling module 230 or the general-purpose processor 206 may perform the second subscription activity during the identified sleep period. In some embodiments, the scheduling module 230 or the general-purpose processor 206 performs a single second subscription activity (e.g., in portions) during a plurality of sleep periods of different CDRX cycles. In some embodiments, the scheduling module 230 or the general-purpose processor 206 performs a plurality of second subscription activities within a single sleep period of a CDRX cycle.

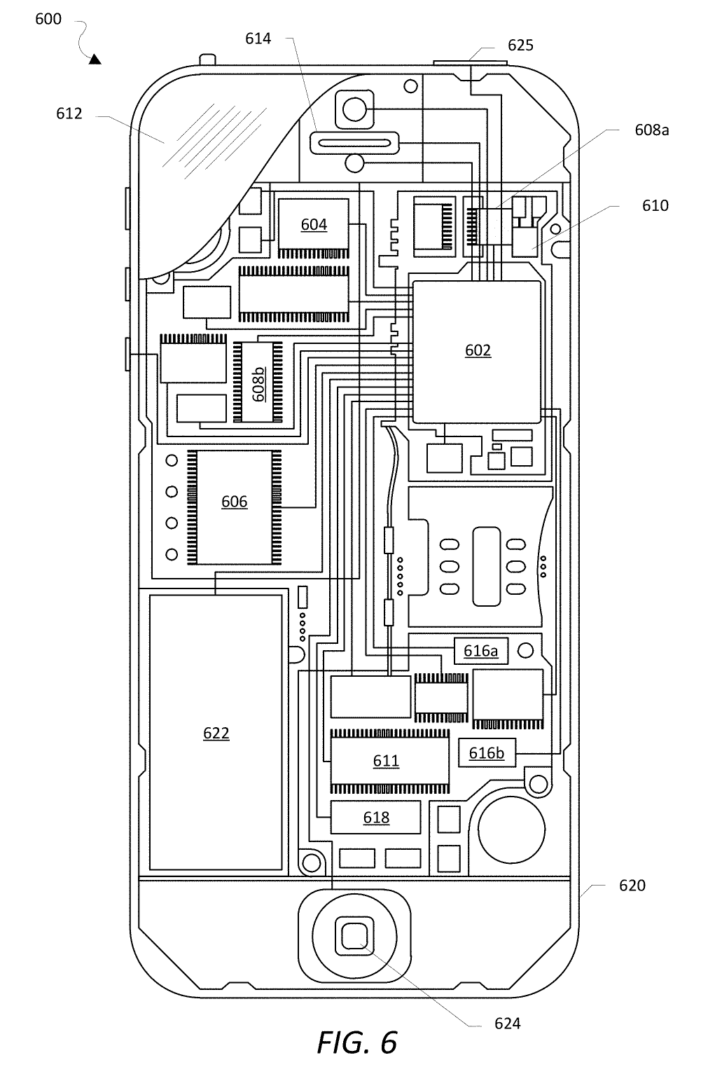

The various embodiments may be implemented in any of a variety of wireless communication devices 110 and 200, an example of which is illustrated in FIG. 6, as a wireless communication device 600. As such, the wireless communication device 600 may implement the process and/or the apparatus of FIGS. 1-6, as described herein.

With reference to FIGS. 1-6, the wireless communication device 600 may include a processor 602 coupled to a touchscreen controller 604 and an internal memory 606. The processor 602 may be one or more multi-core integrated circuits designated for general or specific processing tasks. The memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the wireless communication device 600 need not have touch screen capability.

The wireless communication device 600 may have one or more cellular network transceivers 608a, 608b coupled to the processor 602 and to at least one antenna 610 and configured for sending and receiving cellular communications. The transceivers 608a, 608b and antenna 610 may be used with the above-mentioned circuitry to implement the various embodiment methods. The cellular network transceivers 608a, 608b may be the RF resource 218. The antenna 610 may be the antenna 220. The wireless communication device 600 may include two or more SIM cards 616a, 616b, corresponding to SIM-1 204a and SIM-2 204b (respectively), coupled to the transceivers 608a, 608b and/or the processor 602. The wireless communication device 600 may include a cellular network wireless modem chip 611 (e.g., the baseband modem processor 216) that enables communication via at least one cellular network and is coupled to the processor 602.

The wireless communication device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown).

The wireless communication device 600 may also include speakers 614 for providing audio outputs. The wireless communication device 600 may also include a housing 620, constructed of a plastic, metal, or a combination of materials, for containing all or some of the components discussed herein. The wireless communication device 600 may include a power source 622 coupled to the processor 602, such as a disposable or rechargeable battery. The rechargeable battery may also be coupled to a peripheral device connection port (not shown) to receive a charging current from a source external to the wireless communication device 600. The wireless communication device 600 may also include a physical button 624 for receiving user inputs. The wireless communication device 600 may also include a power button 626 for turning the wireless communication device 600 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the embodiments. Thus, the present embodiments is not intended to be limited to the embodiments shown herein but is to be accorded the widest scope consistent with the following claims and the principles and novel features disclosed herein.

What is claimed is:

1. A method for a wireless communication device having a first Subscriber Identity Module (SIM) associated with a first subscription and a second SIM associated with a second subscription to manage communications over the first subscription and the second subscription, the method comprising:
identifying at least one sleep period of one or more Connected Discontinuous Reception (CDRX) cycles associated with the first subscription; and
performing at least a portion of one or more activities of the second subscription during the identified at least one sleep period.

2. The method of claim 1, further comprising:
identifying an estimated time to complete the one or more activities;
determining a duration of the at least one sleep period; and
determining whether the duration of the at least one sleep period exceeds the estimated time to complete the one or more activities.

3. The method of claim 2, further comprising, in response to determining that the duration of the at least one sleep period exceeds the estimated time to complete the one or more activities, scheduling the one or more activities for execution during the at least one sleep period.

4. The method of claim 2, further comprising, in response to determining that the duration of the at least one sleep period is less than the estimated time to complete the one or more activities, identifying a sleep period of a subsequent CDRX cycle associated with the first subscription, wherein a duration of the sleep period of the subsequent CDRX cycle is equal to or greater than the estimated time to complete the one or more activities.

5. The method of claim 1, wherein the one or more activities of the second subscription comprises idle mode reception activities of the second subscription.

6. The method of claim 5, wherein the idle mode reception activities of the second subscription comprises receiving and decoding pages of the second subscription.

7. The method of claim 1, further comprising:
splitting an idle activity of the one or more activities into a first sub-activity and a second sub-activity; and
scheduling the first sub-activity for execution during a first sleep period of the at least one sleep periods and the second sub-activity for execution during a second sleep period of the at least one sleep periods.

8. The method of claim 7, wherein the first sleep period is associated with a first CDRX cycle of the one or more CDRX cycles and the second sleep period is associated with a second CDRX cycle of the one or more CDRX cycles, and the second CDRX cycle is different from and subsequent to the first CDRX cycle.

9. The method of claim 1, wherein the one or more activities of the second subscription comprises a first activity and a second activity.

10. The method of claim 9, further comprising:
identifying an estimated time to complete the first activity and the second activity;
determining a duration of one of the at least one sleep period; and
determining whether the duration of the one of the at least one sleep period exceeds the estimated time to complete the first activity and the second activity.

11. The method of claim 10, further comprising, in response to determining that the duration of the one of the at least one sleep period exceeds the estimated time to complete the first activity and the second activity, scheduling the first activity and the second activity for execution during the one of the at least one sleep period.

12. The method of claim 1, wherein the first subscription is a Long Term Evolution (LTE) subscription associated with the CDRX.

13. A wireless communication device, comprising:
memory;
at least one Radio Frequency (RF) resource;
a processor operably connected to the at least one RF resource configured to connect to a first Subscriber Identity Module (SIM) associated with a first subscription and to a second SIM associated with a second subscription, the processor further configured to:
identify at least one sleep period of one or more Connected Discontinuous Reception (CDRX) cycles associated with the first subscription; and
perform at least a portion of one or more activities of the second subscription during the identified at least one sleep period.

14. The wireless communication device of claim 13, wherein the processor is further configured to:
identify an estimated time to complete the one or more activities;
determine a duration of the at least one sleep period; and
determine whether the duration of the at least one sleep period exceeds the estimated time to complete the one or more activities

15. The wireless communication device of claim 14, wherein the processor is further configured to, in response to determining that the duration of the at least one sleep period exceeds the estimated time to complete the one or more activities, schedule the one or more activities for execution during the at least one sleep period.

16. The wireless communication device of claim 14, wherein the processor is further configured to, in response to determining that the duration of the at least one sleep period is less than the estimated time to complete the one or more activities, identify a sleep period of a subsequent CDRX cycle associated with the first subscription, wherein a duration of the sleep period of the subsequent CDRX cycle is equal to or greater than the estimated time to complete the one or more activities.

17. The wireless communication device of claim 13, wherein the one or more activities of the second subscription comprises idle mode reception activities of the second subscription.

18. The wireless communication device of claim 17, wherein the idle mode reception activities of the second subscription comprises receiving and decoding pages of the second subscription.

19. The wireless communication device of claim 13, wherein the processor is further configured to:
split an idle activity of the one or more activities into a first sub-activity and a second sub-activity; and
schedule the first sub-activity for execution during a first sleep period of the at least one sleep periods and the second sub-activity for execution during a second sleep period of the at least one sleep periods.

20. The wireless communication device of claim 19, wherein the first sleep period is associated with a first CDRX cycle of the one or more CDRX cycles and the second sleep period is associated with a second CDRX cycle of the one or more CDRX cycles, and the second CDRX cycle is different from and subsequent to the first CDRX cycle.

21. The wireless communication device of claim 13, wherein the one or more activities of the second subscription comprises a first activity and a second activity.

22. The wireless communication device of claim 21, wherein the processor is further configured to:
identify an estimated time to complete the first activity and the second activity;
determine a duration of one of the at least one sleep period; and
determine whether the duration of the one of the at least one sleep period exceeds the estimated time to complete the first activity and the second activity.

23. The wireless communication device of claim 22, wherein the processor is further configured to, in response to determining that the duration of the one of the at least one sleep period exceeds the estimated time to complete the first activity and the second activity, schedule the first activity and the second activity for execution during the one of the at least one sleep period.

24. The wireless communication device of claim 13, wherein the first subscription is a Long Term Evolution (LTE) subscription associated with the CDRX.

25. An apparatus for a wireless communication device having a first Subscriber Identity Module (SIM) associated with a first subscription and a second SIM associated with a second subscription to manage communications over the first subscription and the second subscription, the apparatus comprising:
means for identifying at least one sleep period of one or more Connected Discontinuous Reception (CDRX) cycles associated with the first subscription; and
means for performing at least a portion of one or more activities of the second subscription during the identified at least one sleep period.

26. The apparatus of claim 25, further comprising:
means for identifying an estimated time to complete the one or more activities;
means for determining a duration of the at least one sleep period; and
means for determining whether the duration of the at least one sleep period exceeds the estimated time to complete the one or more activities.

27. The apparatus of claim 26, further comprising, in response to determining that the duration of the at least one sleep period exceeds the estimated time to complete the one or more activities, means for scheduling the one or more activities for execution during the at least one sleep period.

28. A non-transient computer-readable medium comprising program instructions that, when executed, cause a computer to:
identify at least one sleep period of one or more Connected Discontinuous Reception (CDRX) cycles associated with the first subscription; and
perform at least a portion of one or more activities of the second subscription during the identified at least one sleep period.

29. The non-transient computer-readable medium of claim 28, wherein the program instructions further cause the computer to:
identify an estimated time to complete the one or more activities;
determine a duration of the at least one sleep period; and
determine whether the duration of the at least one sleep period exceeds the estimated time to complete the one or more activities.

30. The non-transient computer-readable medium of claim 29, wherein the program instructions further cause the computer to, in response to determining that the duration of the at least one sleep period exceeds the estimated time to complete the one or more activities, schedule the one or more activities for execution during the at least one sleep period.
